(19) United States
(12) Patent Application Publication
(10) Pub. No.: US 2015/0184559 A1
(43) Pub. Date: Jul. 2, 2015

(54) COVER WITH OIL STORAGE FUNCTION FOR A HOUSING OF AN ELECTROHYDRAULIC VALVE DRIVE OF AN INTERNAL COMBUSTION ENGINE

(71) Applicant: Schaeffler Technologies AG & Co. KG, Herzogenaurach (DE)

(72) Inventors: Thomas Kremer, Furth (DE); Michael Haas, Hochstadt (DE)

(73) Assignee: Schaeffler Technologies AG & Co. KG, Herzogenaurach (DE)

(21) Appl. No.: 14/412,758

(22) PCT Filed: Jul. 1, 2013
(86) PCT No.: PCT/EP2013/063841

§ 371 Date: Jan. 5, 2015

(30) Foreign Application Priority Data
Jul. 3, 2012 (DE) 10 2012 211 458.0

(51) Int. Cl. F01L 9/02; B21K 1/26; F02F 7/00

(52) U.S. Cl. CPC F01L 9/02; F02F 7/0065; B21K 1/26

(57) ABSTRACT

A cover (01) with an integrated oil storage function for a housing of an electrohydraulic valve drive for at least one intake valve of an internal combustion engine. According to the invention, an oil storage cavity (02) of each cylinder of the internal combustion engine is directly attached to the cover (01).

### FIELD OF THE INVENTION

The invention relates to a cover for a housing of an electrohydraulic valve drive of an internal combustion engine with integrated oil storage functionality.

### BACKGROUND

Electrohydraulic valve drives have been known for a long time and are described, for example, in EP 0 446 065 A2, DE 3 834 882 A1, and EP 0 317 364 A1.

Another electrohydraulic valve drive is the UniAir principle developed by FIAT, as is known, for example, from EP 0 803 642 A1.

MultiAir is a refinement of the UniAir system. It takes over the valve control on the inlet side and thus makes the corresponding camshaft unnecessary. In this way, each cylinder is provided with its own hydraulic system with a separate hydraulic chamber. An additional cam on the outlet camshaft transmits the valve clearance in a mechanical way to the MultiAir system. If the electronically closed solenoid valve on the hydraulic chamber is closed, no oil flow is possible and the hydraulic chamber behaves like a rigid component. In this case, the valve clearance has a comparable behavior to a conventional system. If, in contrast, the solenoid valve is opened on the hydraulic chamber, cams and valves are mechanically separated from each other. The intake valves now no longer follow the rhythm of the cams but instead close due to the spring force. In this case, a sophisticated mechanism controls the intake valves via solenoid valves tuned to the specific driving conditions. In this way, the air feed into the cylinder is optimally adapted to the actual requirements, which strongly increases the efficiency of the internal combustion engine, especially in the partial load operational range. A control unit here manages the complex mechanism, with the valve position being adapted within fractions of a second due to the interaction between the mechanical and electronic systems.

All of these electrohydraulic systems have in common that as much as possible no air is allowed into the high pressure space of the hydraulic system. Furthermore, an oil reservoir is required to be able to fulfill specified stoppage times and startup procedures.

In the MultiAir system, the oil reservoir is formed as an integral hood that has deep-drawn oil storage cavities and is bolted onto the cover of the engine housing and is sealed from the cover with a bead seal. The cover is sealed from the MultiAir housing with a screen printed seal and bolted to the housing.

Due to production specifications and limited deformation degree, a large volume shape for an oil reservoir in an integral hood is impossible or only barely possible. The production and installation expense is also relatively high.

### SUMMARY

The objective of the invention can be seen in simplifying the oil reservoir of an electrohydraulic valve drive in its production and optimizing the volume of the shape.

This objective is met by a cover for a housing of an electrohydraulic valve drive with one or more features of the invention. A method for producing such a cover is also disclosed.

A housing of an electrohydraulic valve drive of an internal combustion engine, called a MultiAir housing below, is closed by a cover on which, according to the invention, an oil storage cavity is connected directly for each cylinder of the internal combustion engine.

The cover here seals the medium pressure space of the housing of the valve drive and has a cover plate opening to the oil storage reservoir through which air can escape while the engine is running. Here, oil is also transported continuously into the oil storage reservoir, which is almost always filled with oil in the operating state. If the engine is stopped and the oil cools down and is drawn into the medium pressure space, oil can flow back through the cover plate opening into the medium pressure space out from the oil storage reservoir due to the force of gravity.

The advantages of the invention can be seen, in particular, in that at least one seal that was previously required between the cover and the integral hood can be eliminated. Furthermore, the bolting and sealing of the hood on the cover can be eliminated. This means significant material and cost savings both during production and also during installation of the valve control device.

Another advantage is given in that the volume of the oil storage cavities themselves can be easily varied for individual cylinders depending on the engine type and available space in the engine compartment. The oil storage cavities can be adapted in their shape and volume to the available packaging space and its use can be maximized. For several oil storage cavities, it is provided to construct each cover as an identical part, to be able to produce an appropriate number of pieces. Separating the parts increases the possible deformation degree, which benefits the shaping and possible size (volume) of the oil storage cavities.

Advantageously, the cover and the oil storage cavity are produced from sheet steel and soldered to each other. Here, the cover and the necessary openings are stamped from sheet steel. The oil storage cavities are advantageously produced through a deep-drawing process on a steel strip, then cut at the collar, and then brought to the required degree of flatness by means of disc flattening. The joining of the cavities on the cover is realized, for example, by soldering in the continuous annealing furnace. Other joining technologies, for example, laser welding, Plasmatron welding, or the like are also possible if the flatness of the cover is largely maintained during the joining process or if the cover experiences only minimal deformation. The degree of flatness of the cover is here defined by certain sealing solutions relative to the housing (e.g., by bead seals) and must be maintained accordingly.

It is also possible to produce the cover and/or the oil storage cavities from a plastic that satisfies the technical requirements or another material and to join them accordingly. Someone skilled in the art can select the suitable production and joining methods (e.g., thermoforming, bonding, ultrasonic welding, or something else).

The cover can have, in a known way, retaining tabs, e.g., as transport safety devices for the cam followers.

In a preferred embodiment of the invention, the cover has a recess in the area of the oil storage cavity at whose lowest point the cover plate opening is provided. The recess can be produced, for example, by embossing of the cover and preferably has a groove-like or funnel-like shape. This embodiment offers the advantage that even for very unfavorable system positions (e.g., the motor vehicle on an incline), the entire volume of the oil storage cavity can flow back into the medium pressure space of the MultiAir housing.

In a known way, the oil storage cavity has, on its top side, a ventilation hole. This can be formed in the material before or after the shaping of the cavity.

An especially advantageous embodiment in which the cover and oil storage cavity are made from steel can be produced by the following processing steps:
Stamping the cover from sheet steel,
Embossing formed elements on the sheet steel,
Producing at least one cover plate opening for each oil storage cavity in the cover,
Deep drawing of individual oil storage cavities from a steel strip,
Producing a ventilation opening in the oil storage cavities,
Separating the oil storage cavities from the steel strip,
Coating the collars of the oil storage cavities with a solder paste,
Setting the edge of the separated oil storage cavities on retaining sections of the cover,
Joining the oil storage cavities on the cover through soldering in a continuous annealing furnace.

The sequence of the processing steps can obviously be adapted to the technical requirements. If necessary, intermediate steps can also be added if this is necessary. Obviously, someone skilled in the art can adapt the process to the materials to be used for the cover and the oil storage cavities.

### BRIEF DESCRIPTION OF THE DRAWING

A preferred embodiment of the invention is explained in more detail below with reference to the figures.

Shown are:

FIG. 1 a first preferred embodiment of a cover for a housing of an electrohydraulic valve drive of a 4-cylinder engine in a three-dimensional representation,

FIG. 2 the cover shown in FIG. 1 in a top view,

FIG. 3 the cover shown in FIG. 1 in a sectional representation along the section line A-A in FIG. 2,

FIG. 4 the cover shown in FIG. 1 in a sectional representation along the section line B-B in FIG. 2, and

FIG. 5 a second preferred embodiment of a cover according to the invention with a recess in a longitudinal sectional representation.

### DETAILED DESCRIPTION OF THE PREFERRED EMBODIMENTS

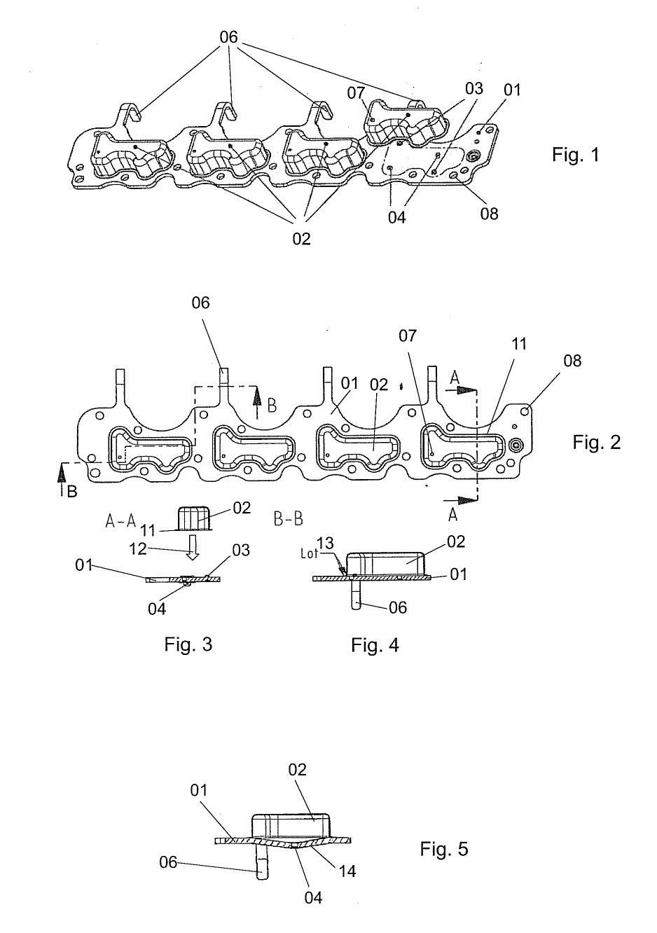

FIG. 1 shows a three-dimensional representation of a cover 01 for an electrohydraulic valve drive of a 4-cylinder engine. FIG. 2 is a top view of the cover according to FIG. 1. A first preferred embodiment of the invention will be explained below with reference to these two figures.

Four individual oil storage cavities 02 are mounted on the cover 01. In this way, one of the oil storage cavities 02 is allocated to each cylinder of the engine and arranged on the cover 01 so that it is located above a medium pressure space of a solenoid valve device of the valve drive when the cover 01 closes the not-shown MultiAir housing. Advantageously, a seal is provided between the MultiAir housing and cover 01 and this seal can be, for example, a screen printed gasket, bead gasket, or another suitable seal.

On the right in FIG. 1, a single oil storage cavity is shown before it is connected to the cover 01. Here it can be seen that formed elements 03 are embossed on the cover 01 and these formed elements are used to position and fix the oil storage cavity 02 correctly before the final joining with the cover 01.

Two cover plate openings 04 are formed in the cover 01 in the area of the oil storage cavity 02. The cover plate openings 04 are used for venting the medium pressure space of the not-shown MultiAir housing while the engine is running and allow a return of oil from the oil storage cavity 02 into the MultiAir housing when the engine is stopped. The number of cover plate openings can vary.

The cover 01 has, in a known way, retaining tabs 06 that are used as transport safety devices for the cam followers for actuating a pump of the electrohydraulic valve drive by the cam.

The oil storage cavities 02 each have a ventilation opening 07 on their top side.

The cover 01 has several holes 08 that are used to mount the cover on the MultiAir housing, advantageously using bolts.

With reference to FIGS. 3 and 4, a preferred production method for the cover according to the invention is now described. FIG. 3 shows a section along the section line A-A in FIG. 2; FIG. 4 shows a section along the section line B-B in FIG. 2.

The oil storage cavity 02 is initially arranged above the cover 01 so that the cover plate openings 04 and the formed elements 03 are located under the base area of the oil storage cavity 02. Then the oil storage cavity 02 initially pretreated with solder paste or the like on a collar 11 is set on the cover 01, as indicated by the arrow 12. The oil storage cavity 02 is held in position up to the final joining by solder 13 by the formed elements 03. The joining process itself can be performed by soldering in a continuous annealing furnace.

FIG. 5 shows a modified embodiment of the invention in which a recess 14 has been generated, for example, by embossing, in the cover 01 in the area of the oil storage cavity 02. The recess 14 advantageously has a funnel-shaped construction.

At the deepest point of the recess 14, the at least one ventilation opening 06 is arranged. Thus it is guaranteed that even in the most unfavorable position of the engine, almost all of the oil can run back into the housing by itself out from the oil storage cavity 02.

### LIST OF REFERENCE NUMBERS

01 Cover
02 Oil storage cavity
03 Formed element
04 Cover plate opening
05 —
06 Retaining tab
07 Ventilation opening
08 Hole
09 —
10 —
11 Collar
12 Arrow for installation direction
13 Solder
14 Recess

1. A cover assembly with integrated oil storage for a housing of an electrohydraulic valve drive for at least one intake valve of an internal combustion engine, the cover assembly comprising a cover plate and a separate oil storage cavity attached directly on the cover plate for each cylinder of the internal combustion engine.

2. The cover assembly according to claim 1, wherein the cover plate is formed of stamped sheet steel.

3. The cover assembly according to claim 1, wherein the oil storage cavity is formed of deep-drawn sheet steel.

4. The cover assembly according to claim 2, wherein the oil storage cavity is soldered onto the cover plate.

5. The cover assembly according to claim 1, wherein the cover plate and the oil storage cavity are made from plastic.

6. The cover assembly according to claim 1 wherein at least one cover plate opening is provided on the cover plate underneath each of the oil storage cavities.

7. The cover assembly according to claim 6, further comprising a recess in an area of the oil storage cavity, and the cover plate opening is provided at a lowest point of the recess.

8. The cover assembly according to claim 7, wherein the recess has a groove shape or funnel shape.

9. The cover assembly according to claim 1, wherein the oil storage cavity has a ventilation opening on a top side thereof.

10. A method for producing a cover assembly with integrated oil storage for a housing of an electrohydraulic valve drive of an internal combustion engine, comprising the following steps:
stamping a cover plate from sheet steel,
embossing formed elements on the sheet steel,
producing at least one cover plate opening for each oil storage cavity in the cover assembly,
deep drawing of individual oil storage cavities from a steel strip,
producing a ventilation opening in the oil storage cavities,
separating the oil storage cavities from the steel strip,
coating collars of the oil storage cavities with a solder paste,
setting an edge of the separated oil storage cavities on retaining sections of the cover plate, and
joining the oil storage cavities on the cover plate through soldering in a continuous annealing furnace.
